(19) United States
(12) Patent Application Publication
(10) Pub. No.: US 2019/0273405 A1
(43) Pub. Date: Sep. 5, 2019

(54) MOTOR COMPRISING HALBACH ARRAY AND APPARATUS COMPRISING SAME

(71) Applicant: NOVOMOTO LIMITED, Hong Kong (CN)

(72) Inventor: Kwok Pun Ho, Hong Kong (CN)

(21) Appl. No.: 16/348,946

(22) PCT Filed: Nov. 10, 2017
(86) PCT No.: PCT/CN2017/110443

§ 371 Date: May 10, 2019

(30) Foreign Application Priority Data
Nov. 11, 2016 (CN) 201610994572.5

(51) Int. Cl. H02K 1/17; H02K 1/27

(52) U.S. Cl. CPC H02K 1/17; H02K 1/2786

(57) ABSTRACT

A motor comprising a HALBACH array and an apparatus comprising the motor, the motor including an assembly of a stator and a rotator, a plurality of tooth structures and groove structures are formed on the opposite surfaces of the stator and the rotator. The motor further includes a plurality of HALBACH array permanent magnet units distributed in the plurality of grooves of the stator and/or the rotator. By using the above motor, the plurality of HALBACH array permanent magnet units are respectively distributed in the grooves of the stator and/or the rotator to form a simple HALBACH array arrangement, therefore the torque density of the motor can be improved, the mass production of the permanent magnet can be facilitated, the production cost can be reduced, and the installation can be facilitated and not easily damaged.

### TECHNICAL FIELD

The present disclosure relates to the field of motor technology, and in particular, to a motor comprising HALBACH array and an apparatus comprising same.

### BACKGROUND

Recently, in the field of permanent magnet motors, tooth structures and groove structures on the opposite surfaces of the stator and/or the rotator are generally used to place a single permanent magnet in the groove, but the motor using the structure tends to have a small torque density, with the development of the industry robot, motors that can achieve high torque densities are required, while the motors with the above-mentioned structure cannot meet the requirements.

In order to achieve high torque density, HALBACH array permanent. magnets have been used. HALBACH array permanent magnets utilize the superposition and cancellation of the magnetic field in the middle superimposed and offset, so that the magnetic field strength of the single side is enhanced, and the air gap magnetic density of the motor can be improved. Thus, the HALBACH array permanent magnets have been widely used in the field of permanent magnet motors, as mentioned in the Chinese patent NO. CN203278585, as shown in FIG. 6, the rotor of the motor comprises a HALBACH array arranged on the opposite sides of the rotor and the stator, and the HALBACH array adopting such an arrangement requires a plurality of permanent magnets of various magnetization directions to be combined, so that the processing is complicated and costly, and the arrangement of the array requires the permanent magnets located in the middle to be in close contact with each other, which is difficult to be assembled and easily causes damage to the permanent magnets.

### SUMMARY

In order to solve the above problems, the present disclosure provides a motor comprising HALBACH array and an apparatus comprising same, a plurality of HALBACH array permanent magnet units are respectively distributed in grooves of a stator and/or a rotator to form a simple HALBACH array arrangement. Therefore, the torque density of the motor can be improved, the mass production of the permanent magnet can be facilitated, the production cost can be reduced, and the installation can be facilitated and not easily to be damaged.

A first aspect of the present disclosure provides a motor with an assembly of a stator and a rotator, a plurality of tooth structures and groove structures are formed on the opposite surfaces of the stator and the rotator, the motor further comprises a plurality of HALBACH array permanent magnet units distributed in the plurality of grooves of the stator and/or the rotator.

Further, each of the HALBACH array permanent magnet units has the same shape, and a direction of a formed single-sided magnetic field corresponds to a gap between the rotator and the stator.

Further, one end of the permanent magnets at least located at both sides of the HALBACH array permanent magnets distributed in each of the grooves which is close to the opposite surface of the stator or the rotator is at a distance lower than the same end of the permanent magnet located in the middle.

Further, a height ratio of the height of the permanent magnets located at both sides to the permanent magnet located in the middle includes: 1.5:1 to 1.9:1.

Further, a width of the permanent magnet located in the middle of each of the HALBACH array permanent magnet units is larger than a width of the permanent magnets located at both sides of each of the HALBACH array permanent magnet units.

Further, a ratio of the width of the permanent magnet located in the middle and the width of the permanent magnets located at both sides is 2.5:1.

Further, each of the HALBACH array permanent magnets includes: at least a first permanent magnet, a second permanent magnet, and a third permanent magnet which are arranged in a lateral direction.

Further, the plurality of HALBACH array permanent magnet units distributed in the plurality of grooves of the stator and/or the rotator include:

a HALBACH array permanent magnet unit distributed in each groove or in every several grooves; or

a plurality of HALBACH array permanent magnet units distributed in each groove or in every several grooves.

A second aspect of the present disclosure provides an apparatus comprising the motor as described above.

As can be seen from the above, the present disclosure provides the motor in which a plurality of HALBACH array permanent magnet units are respectively distributed in the grooves of the stator and/or the rotator to form a simple HALBACH array arrangement, which achieves the following technical effects:

1. The plurality of HALBACH array permanent magnet units are distributed in each groove of the stator and/or the rotator due to the plurality of teeth and groove structures formed on opposite sides of the stator and the rotator, forming the simple HALBACH array arrangement, which can improve the torque density of the motor, facilitate the mass production of the permanent magnets, reduce the production cost, and is easy to be installed and not easily to be damaged.

2. Since the shape of each HALBACH array permanent magnet unit is the same, in order to ensure that the direction of the formed single-sided magnetic field corresponds to the gap between the rotator and the stator, only the installation direction of the permanent magnets constituting the HALBACH array unit need to be adjusted, so mass production can be completed to the maximum extent, ensuring the convenience of installation and product consistency.

3. Since the first permanent magnet and the third permanent magnet are located at least one end of the opposite side of the rotator or the stator is lower than the same end of the second permanent magnet, by adopting the above structure, on the one hand, since the area affected by the reverse magnetization is removed, the entire HALBACH array permanent magnet is not demagnetized, which affects the stability of the entire motor; on the other hand, since some of the permanent magnet structures are removed, the mass of each group of HALBACH arrays can be relatively reduced, thus reducing the weight of the motor to a certain extent.

4. Since the width of the permanent magnet located in the middle of each HALBACH array permanent magnet is larger than the width of the permanent magnets located on both sides of each HALBACH array permanent magnet, a better sinusoidal magnetic field can be formed.

### BRIEF DESCRIPTION OF DRAWINGS

In order to more clearly illustrate the technical solutions of the embodiments of the present disclosure, the drawings used in the embodiments and the prior art description will be briefly described below. Obviously, the drawings in the following description are only some implementations of the present disclosure. For example, other drawings may be obtained by those skilled in the art without any inventive effort based on the following drawings.

FIG. 1 is a partial structural schematic view of a linear motor according to an embodiment of the present disclosure;

FIG. 2 is a schematic structural diagram of a rotating motor according to an embodiment of the present disclosure, wherein the right side illustrates an enlarged schematic view of a portion A;

FIG. 3A-FIG. 3D are schematic diagrams showing several embodiments of a magnetic flux direction on each HALBACH array permanent magnet according to embodiments of the present disclosure;

FIG. 4A-FIG. 4D are schematic diagrams of several embodiments of each HALBACH array permanent magnet according to embodiments of the present disclosure;

FIG. 5 is a schematic diagram of an embodiment of a motor according to an embodiment of the present disclosure;

FIG. 6 illustrates a magnetic density change of each permanent magnet in a HALBACH array permanent magnet according to an embodiment of the present disclosure;

FIG. 7A-FIG. 7B are schematic diagrams illustrating two embodiments of a HALBACH array permanent magnet according to embodiments of the present disclosure;

FIG. 8 is a top plan view of a conventional motor.

### DETAILED DESCRIPTION

In order to enable those skilled in the art to better understand the solution of the present disclosure, the technical solutions in the embodiments of the present disclosure will be clearly and completely described in the following with reference to the drawings in the embodiments of the present disclosure. It is apparent that the described embodiments are merely a part of the embodiments of the disclosure, and not all of the embodiments. All other embodiments obtained by a person of ordinary skill in the art based on the embodiments of the present disclosure without departing from the inventive scope should fall within the scope of the present disclosure.

### Embodiment 1

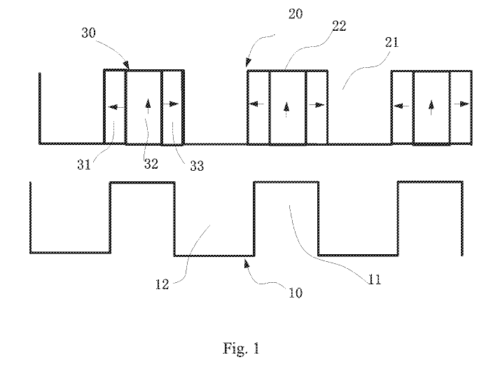

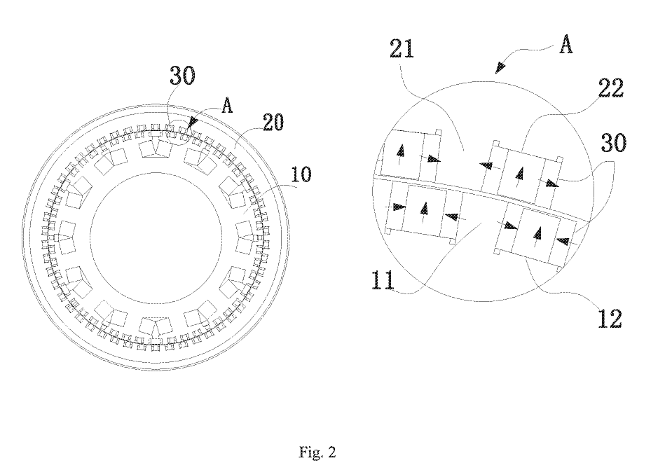

FIG. 1 is a schematic structural diagram of a portion of a linear motor according to an embodiment of the present disclosure; FIG. 2 is a schematic structural view of a rotating motor according to an embodiment of the present disclosure, wherein the right side is an enlarged schematic view of a portion A.

In the field of permanent magnet motors, there are currently permanent magnet motors employing HALBACH arrays, as described in the background, in which the opposite surfaces of the rotor and stator are enclosed by a HALBACH array, The HALBACH array adopting such an arrangement requires a plurality of permanent magnets of various magnetization directions to be combined, and the processing thereof is complicated, and the arrangement of the array requires the permanent magnets located in the middle to be in close contact with each other, so that it is difficult to be assembled and easily cause damage to permanent magnets.

As shown in FIG. 1 and FIG. 2, in order to solve the above problems, the present disclosure provides a motor including an assembly of a stator 10 and a rotator 20, and a plurality of tooth 11, 21 structures and groove 12, 22 structures are formed on the opposite surfaces of the stator 10 and the rotator 20. The grooves 12, 22 are configured such that a plurality of HALBACH array permanent magnets 30 are distributed within each groove of the stator 10 and/or the rotator 20.

Since the plurality of HALBACH array permanent magnet units are respectively distributed in the grooves of the stator and/or the rotator to form a simple HALBACH array arrangement, the torque density of the motor can be improved (compared with the conventional motor with a single permanent magnet, with a whole permanent magnet of the same size, the torque of the motor using the structure of the disclosure is 2.5 times of that of the existing motor), which also contributes to the mass production of the permanent magnet, reduces the production cost, and is convenient to be installed and not easily to be damaged.

It should be noted that the motor may include an electric motor that converts electrical energy into kinetic energy output (the electric motor may include: a rotary motion rotary motor, a linear motion linear motor); and may also include an electric generator that converts kinetic energy into electrical energy output. In some cases, the two can be realized by the same structure, and the functions of the generator or the motor are respectively realized by adopting different electrical connections and mechanical connections to the same structure.

In some exemplary embodiments, the shapes of the respective HALBACH array units are the same, so that the requirements of mass production can be satisfied to the greatest extent, just adjusting installation directions of the permanent magnets that make up each of the HALBACH array permanent magnet units according to the direction of single-sided magnetic field generated by each HALBACH array permanent magnet units during installing is required to enable the single-sided magnetic field generated by each of the HALBACH array permanent magnet units installed on the stator and/or the rotator corresponds to the gap direction of the stator and the rotator(as the magnetic flux direction shown in the enlarged view on the right side of FIG. 2). In addition to the exemplary manners, the shape of each. HALBACH array permanent magnet unit does not have to be the same, for example, the HALBACH array unit located in the stator grooves can be different in shape from the HALBACH array unit located in the rotator grooves, just ensuring the single-sided magnetic field generated by the HALBACH array on the stator and the rotator corresponds to the gap direction of the rotator and the stator. The single-sided magnetic field formed by the upper HALBACH array may correspond to the gap direction of the rotator and the stator.

It should be noted that the opposite surfaces of the stator and the rotator form a plurality of teeth and a plurality of grooves, and preferably, the plurality of HALBACH array permanent magnet units are respectively distributed in the grooves of the stator and the rotator as shown in FIG. 2, so that a greater torque density of the motor can be achieved to a greater extent. When such an arrangement is adopted, it is only necessary to ensure that the single-sided magnetic field formed by each of the HALBACH array permanent magnet units on the stator and/or the rotator corresponds to the gap direction of the rotator and the stator. In addition to the configurations described in the previous paragraph, it is also possible to provide HALBACH array permanent magnets only in the grooves of the rotator (as shown in FIG. 1), or to provide HALBACH array permanent magnets only in the grooves of the stator (not shown).

It should be further noted that, in each of the foregoing setting manners, it is preferable that at least one HALBACH array unit is distributed in each groove of the stator and/or the rotator (that is, one HALBACH array is distributed in each groove, or a plurality of HALBACH array units are distributed in each groove); or it is not necessary to distribute one HALBACH array unit in each groove, for example, at least one HALBACH array unit is distributed every several grooves.

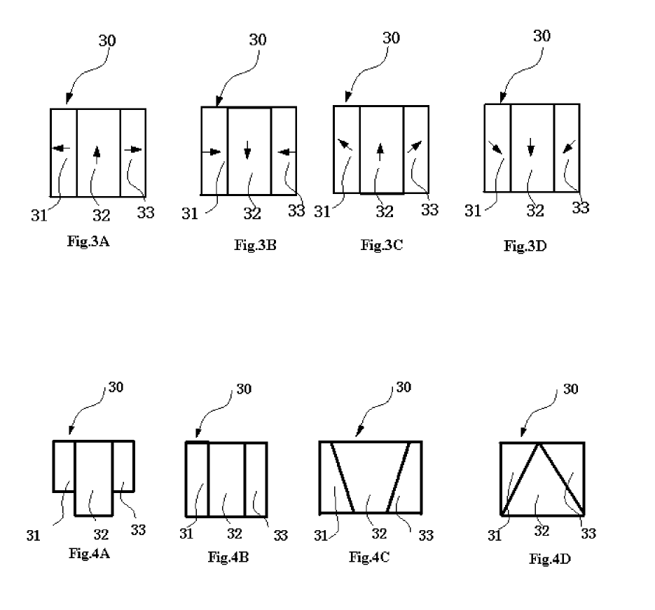

FIG. 3A-FIG. 3D are schematic diagrams illustrating several embodiments of magnetic flux directions on each of the HALBACH array permanent magnets according to some embodiments of the present disclosure. FIG. 4A-FIG. 4D are schematic diagrams illustrating several embodiments of each of the HALBACH array permanent magnets according to some embodiments of the present disclosure.

As shown in FIG. 1, each of the HALBACH array permanent magnets 30 includes: at least a first permanent magnet 31, a second permanent magnet 32, and a third permanent magnet 33 which are arranged in a lateral direction.

The first permanent magnet 31 includes a first magnetic flux direction,

The second permanent magnet 32 includes a second magnetic flux direction,

The third permanent magnet 33 includes a third magnetic flux direction.

The first magnetic flux direction, second magnetic flux direction, and third magnetic flux direction may be any combination of directions satisfying the HALBACH array principle, so that the single-sided magnetic field generated by the combined HALBACH array corresponds to the gap between the stator and the stator. In the present embodiment, as shown in FIG. 3A-FIG. 3D, the second magnetic flux direction is preferably perpendicular (either completely perpendicular or approximately perpendicular) to the opposite surfaces of the stator or the rotator, and the first magnetic flux direction and the third magnetic flux direction are mutually symmetrical or antiparallel.

As shown in FIG. 4A-FIG. 4D, the respective permanent magnets constituting the HALBACH array can be designed in various shapes as needed.

As shown in FIG. 4A and FIG. 4B, the shapes of the first permanent magnet, the second permanent magnet, and the third permanent magnet are preferably rectangular.

As shown in FIG. 4C, the HALBACH array includes the first permanent magnet, the second permanent magnet, and the third permanent magnet that are respectively trapezoidal.

As shown in FIG. 4D, the HALBACH array includes the first permanent magnet, the second permanent magnet, and the third permanent magnet that are respectively triangular.

In addition to the shapes of the first permanent magnet, the second permanent magnet, and the third permanent magnet illustrated in FIG. 4 in the present embodiment, any permanent magnet shape that satisfies the HALBACH array principle is within the scope of the present disclosure.

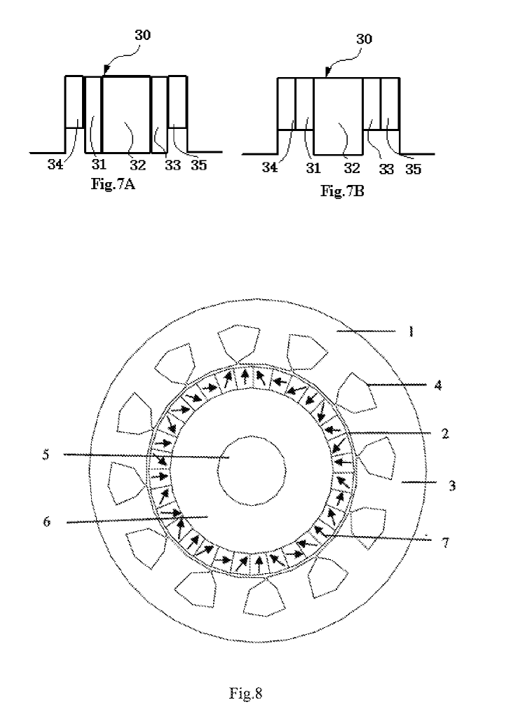

FIG. 7A-FIG. 7B are schematic diagrams illustrating two embodiments of a HALBACH array permanent magnet according to embodiments of the present disclosure.

The number of the HALBACH array permanent magnets is preferably three including the first permanent magnet, the second permanent magnet, and the third permanent magnet, but the number of the permanent magnets is not limited to three, and may be five (as shown in FIG. 7A, FIG. 7B), seven, nine, etc., with the second permanent magnet as the center, any number of equal permanent magnets can be added to both sides. For the other related permanent magnets, reference may be made to the related descriptions of the first and third permanent mamas, and the detailed description thereof will not be repeated here.

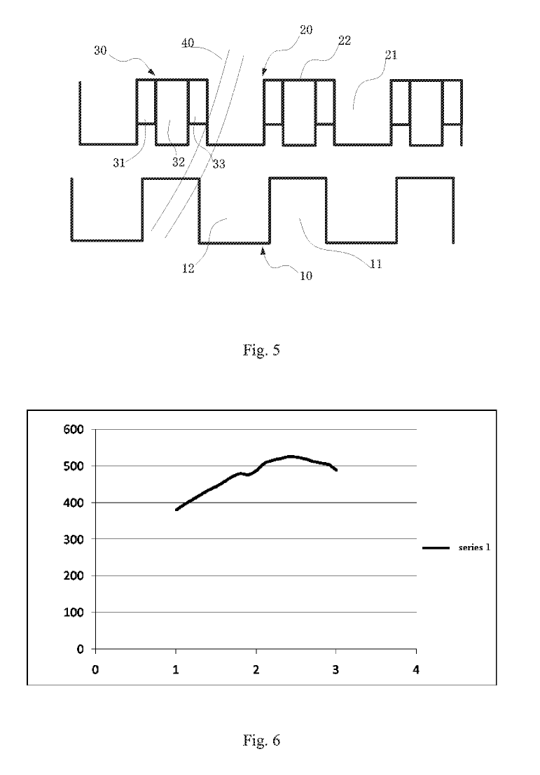

FIG. 5 is a schematic diagram of an embodiment of a motor according to an embodiment of the present disclosure.

As shown in FIG. 5, in some preferred embodiments, in some of the HALBACH array permanent magnets in each groove in a motor with relatively high magnetic density, the ends of the permanent magnets on both sides are subjected to the influence of magnetic lines of flux 40 passing through. When the direction of the magnetic line 40 is different from the direction of the magnetic field of the permanent magnet itself, may cause demagnetization of the permanent magnet, thereby affecting the stability of the entire motor. In order to solve the above problem, the embodiment of the present disclosure preferably has one end of the permanent magnets at least located at both sides of the HALBACH array which is close to the opposite surface of the rotator or the stator at a certain distance lower than the same end of the permanent magnet located in the middle of the HALBACH array.

By adopting the above structure, on the one hand, since the region affected by the demagnetization is removed, the entire HALBACH array permanent magnet is not demagnetized, which affects the stability of the entire motor; on the other hand, due to the removal of part of the permanent magnet structure, the mass of each group of HALBACH array permanent magnets is relatively reduced, thereby reducing the weight of the motor to some extent.

As shown in FIG. 5, taking the HALBACH array including three permanent magnets (the first permanent magnet 31, the second permanent magnet 32 and the third permanent magnet 33) as an example, the end of the first permanent magnet 31 and the end of the third permanent magnet 33 close to the opposite surface the rotator or the stator are at a certain distance lower than the same end of the second permanent magnet 32.

The HALBACH array permanent magnet includes five permanent magnets (the first permanent magnet 31, the second permanent magnet 32, the third permanent magnet 33, the third permanent magnet 34 and the third permanent magnet 35), preferably as illustrated in FIG. 7A, the end of the fourth permanent magnet 34 and the end of the five permanent magnet 35 close to the opposite side of the rotator or the stator are at a certain distance lower than the same end of the second permanent magnet 32 located in the middle; or may be the end of the first permanent magnet 31, the end of the third permanent magnet 33, the end of the fourth permanent magnet 34 and the end of the five permanent magnet 35 close to the opposite side of the rotator or the stator are at a certain distance lower than the same end of the second permanent magnet 32 located at the middle, as described in FIG. 7B.

In some preferred embodiments, the height ratio of the permanent magnets located at both sides to the height of the permanent magnet located in the middle includes: 1:1.5 to 1:1.9. As shown in FIG. 5, the height ratio of the height of the first permanent 31 and the third permanent magnet 33 to the height of the second permanent magnet 32 preferably includes 1:1.5 to 1:1.9.

However, it should be noted that the height ratio of each of the permanent magnets is not limited to the range of values listed above, and there may be other changes depending on the different specifications of the motors and the specifications of the HALBACH array permanent magnets used, It is within the scope of the present disclosure to ensure that the missing portions of the first permanent magnet and the second permanent magnet are part of the range that may be adversely magnetized by magnetic lines of flux.

FIG. 6 is a diagram illustrating changes in magnetic density of each permanent magnet in a HALBACH array permanent magnet according to a width change ratio according to an embodiment of the present disclosure.

In some preferred embodiments, the width of the permanent magnet located in the middle of each of the HALBACH array permanent magnets is greater than the width of the permanent magnets located at both sides, so that a better sinusoidal magnetic field can be generated. As shown in FIG. 6, it is assumed that the width of the second permanent magnet 32 is P, the widths of the first permanent magnet 31 and the third permanent magnet 33 are T, and when the ratio of the two is about 2.5, the magnetic moment density is maximum.

It should be noted that the width ratio is not limited to the ratio described above, as long as the width of the second permanent magnet 32 located in the middle is greater than the widths of the first permanent magnet 31 and the third permanent magnet 33 which are located at both sides, it is within the scope of a preferred embodiment of the disclosure.

When more than 5 permanent magnets are included in the HALBACH array permanent magnet, the other permanent magnets can be referred to the related design of the second and third permanent magnets.

### Embodiment 2

The second embodiment of the present disclosure further provides an apparatus, wherein the apparatus includes the motor of the first embodiment.

The motor is described in the first embodiment, and the details are not repeated herein. In the above embodiments, the descriptions of the various embodiments are different, and the parts that are not described in detail in a certain embodiment can be referred to the related description of other embodiments.

It should be noted that those skilled in the art should also understand that the embodiments described in the specification are all exemplary embodiments, and the structures and modules involved are not necessarily required by the present disclosure.

The motor comprising the HALBACH array and the apparatus comprising same provided by the embodiments of the present disclosure are described in detail above, but the description of the above embodiments is only for helping to understand the method and the core idea of the present disclosure, and should not be construed as the limits of the present disclosure. Those skilled in the art, in light of the spirit of the present disclosure, are susceptible to variations and substitutions within the scope of the present disclosure.

1. A motor comprising HALBACH array, the motor comprising:
an assembly of a stator and a rotator;
a plurality of tooth structures and groove structures formed on opposite surfaces of the stator and the rotator; and
a plurality of HALBACH array permanent magnet units distributed in the plurality of grooves of the stator and/or the rotator.

2. The motor comprising HALBACH array according to claim 1, wherein each of the plurality of HALBACH array permanent magnet units has the same shape, and a direction of a formed single-sided magnetic field corresponds to a gap between the rotator and the stator.

3. The motor comprising HALBACH array according to claim 1, wherein one end of the permanent magnets at least located at both sides of the HALBACH array permanent magnets distributed in each of the plurality of grooves which is close to the opposite surface of the stator or the rotator is at a distance lower than the same end of the permanent magnet located in a middle.

4. The motor comprising HALBACH array according to claim 3, wherein a height ratio of a height of the permanent magnets located at both sides to a height of the permanent magnet located in the middle comprises: 1.5:1 to 1.9:1.

5. The motor comprising HALBACH array according to claim 1, wherein a magnetic flux direction of the permanent magnet located in a middle of each of the HALBACH arrays is perpendicular to the opposite surface of the stator or the rotator, and the magnetic flux directions of the permanent magnets respectively located at right and left sides are symmetrical or antiparallel to each other.

6. The motor comprising HALBACH array according to claim 1, wherein a width of the permanent magnet located in a middle of each of the HALBACH array permanent magnet units is larger than a width of the permanent magnets located at both sides of each of the HALBACH array permanent magnet units.

7. The motor comprising HALBACH array according to claim 6, wherein a ratio of the width of the permanent magnet located in the middle and the width of the permanent magnets located at both sides is 2.5:1.

8. The motor comprising HALBACH array according to claim 1, wherein each of the HALBACH array permanent magnets comprises: at least a first permanent magnet, a second permanent magnet, and a third permanent magnet which are arranged in a lateral direction.

9. The motor comprising HALBACH array according to claim 1, wherein the plurality of HALBACH array permanent magnet units distributed in the plurality of grooves of the stator and/or the rotator comprise:
a HALBACH array permanent magnet unit distributed in each groove of the plurality of grooves or in every several grooves of the plurality of grooves; or
a plurality of HALBACH array permanent magnet units distributed in each groove of the plurality of grooves or in every several grooves of the plurality of grooves.

10. An apparatus comprising the motor comprising HALBACH array according to claim 1.
